(19) United States
(12) Patent Application Publication
(10) Pub. No.: US 2026/0360637 A1
(43) Pub. Date: Nov. 12, 2026

(54) Modular Reconfigurable Keypad

(71) Applicant: The Watt Stopper, Inc., Carlsbad, CA (US)

(72) Inventors: Zhijun Xu, Shanghai (CN); Louia Muller Weidman, Vista, CA (US); Lixin Zhang, Shanghai (CN); Hui Lyu, Shanghai (CN)

(73) Assignee: The Watt Stopper, Inc., Carlsbad, CA (US)

(21) Appl. No.: 19/475,341

(22) PCT Filed: Apr. 14, 2023
(86) PCT No.: PCT/IB2023/053849

§ 371 Date: Oct. 14, 2025

(51) Int. Cl. H01H 13/83; H01H 13/86; H01H 13/88

(52) U.S. Cl. CPC H01H 13/83; H01H 13/86; H01H 13/88; H01H 2219/002; H01H 2219/04; H01H 2219/056; H01H 2229/022; H01H 2233/032; H01H 2300/03

(57) ABSTRACT

Modular button assemblies, keypad systems including the modular button assemblies, and methods of use are provided. The modular button assemblies each include a button cap and a button body assembly releasably coupled to the button cap. The button body assembly includes a circuit board programmable with functionality of the modular button assembly, one or more buttons coupled to the circuit board for controlling the functionality of the modular button assembly through the circuit board, one or more electrical contacts extending from the circuit board, and a button housing configured to at least partially encase the circuit board, the one or more buttons, and the one or more electrical contacts. The button body assembly is capable of engagement and disengagement relative to a keypad housing while maintaining the functionality programmed into the circuit board.

### BACKGROUND

A variety of keypads or switch assemblies are used for home automation, security systems, or the like. Such keypads typically include multiple buttons, with each button programmed to perform a specific function. For example, keypads can include multiple buttons for activating different light fixtures in a room. Replacement of the buttons in such keypads (if possible) typically necessitates difficult disassembly of multiple components and reprogramming of the button and/or sensors associated with the button.

### SUMMARY

In accordance with embodiments of the present disclosure, an exemplary modular button assembly is provided. The modular button assembly includes a button cap and a button body assembly releasably coupled to the button cap. The button body assembly includes a circuit board programmable with functionality of the modular button assembly, and one or more buttons coupled to the circuit board for controlling the functionality of the modular button assembly through the circuit board. The button body assembly includes one or more electrical contacts extending from the circuit board, and a button housing configured to at least partially encase the circuit board, the one or more buttons, and the one or more electrical contacts. The button body assembly is capable of engagement and disengagement relative to a keypad housing while maintaining the functionality programmed into the circuit board.

In some embodiments, the button cap can include an assembly of a top panel and a mounting plate. In some embodiments, the top panel and the mounting plate can include complementary locating rings for alignment and coupling of the top panel to the mounting plate. The button housing can include one or more openings configured to receive therethrough the one or more electrical contacts. The one or more electrical contacts can extend from an outer surface of the button body assembly for electrical coupling and decoupling relative to the keypad housing.

In some embodiments, the button body assembly can include a mounting base and a light diffuser disposed at least partially within the mounting base. The mounting base can include a body with a central opening and tapered inner walls. The tapered inner walls can define an angle complementary to tapered walls of the light diffuser. The button body assembly can include one or more light emitting diodes (LEDs) electrically mounted to the circuit board and aligned with a bottom point of the light diffuser.

In some embodiments, the button cap can include text indicating the functionality of the modular button assembly. In some embodiments, the button body assembly can include a base plate releasably engaged with the button housing and configured to at least partially enclose the one or more electrical contacts extending from the circuit board.

In accordance with embodiments of the present disclosure, an exemplary reconfigurable keypad is provided. The keypad includes a housing including recessed portions with electrical contacts, and at least one modular button assembly. The modular button assembly includes a button cap, and a button body assembly releasably coupled to the button cap. The button body assembly includes a circuit board programmable with functionality of the modular button assembly, and one or more buttons coupled to the circuit board for controlling the functionality of the modular button assembly through the circuit board. The button body assembly includes one or more electrical contacts extending from the circuit board, and a button housing configured to at least partially encase the circuit board, the one or more buttons, and the one or more electrical contacts. The at least one modular button assembly is capable of engagement and disengagement relative to the recessed portions of the housing while maintaining the functionality programmed into the circuit board.

In some embodiments, the housing can include multiple rows of the recessed portions, and the at least one modular button assembly is capable of engagement and disengagement to any areas of the recessed portions of the housing. In some embodiments, a position of the at least one modular button assembly relative to the recessed portions of the housing is interchangeable without affecting the functionality of the at least one of modular button assembly.

In some embodiments, the housing can include a faceplate extending from edges of a rear section of the housing and configured to be installed against an outer surface of a wall. In some embodiments, the housing can include a removable front plate detachably coupled to the faceplate of the housing. The faceplate and the removable front plate can include aligned openings capable of receiving the one or more modular button assemblies therethrough.

In some embodiments, the button cap can include a multi-part design including an identifier plate coupled between a translucent outer plate and a mounting plate. In such embodiments, the identifier plate can be interchangeable. In some embodiments, the button cap can include a single-part design including an outer surface with identifier information formed in the outer surface, and a mounting or fastening structure extending from an opposing surface of the button cap.

In accordance with embodiments of the present disclosure, and exemplary method of keypad reconfiguration is provided. The method includes inserting a modular button assembly into a first position of a recessed portion of a keypad housing to make an electrical contact of the housing with one or more electrical contacts of the modular button assembly. The modular button assembly includes a button cap and a button body assembly releasably coupled to the button cap. The button body assembly includes a circuit board programmable with a functionality of the modular button assembly, one or more buttons coupled to the circuit board for controlling the functionality of the modular button assembly through the circuit board, the one or more electrical contacts extending from the circuit board, and a button housing configured to at least partially encase the circuit board, the one or more buttons, and the one or more electrical contacts. The method includes removing the modular button assembly from the first position of the recessed portion of the keypad. The method includes inserting the modular button assembly in a second position of the recessed portion of the keypad, the second position is different from the first position. The modular button assembly maintains the functionality programmed into the circuit board during insertion and removal of the modular button assembly from the recessed portion of the keypad.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1A is a perspective view of a modular reconfigurable keypad in accordance with some embodiments, including multiple modular button assemblies.

FIG. 1B is an exploded perspective view of the keypad shown in FIG. 1A.

FIG. 2A is a perspective view of a modular button assembly in accordance with some embodiments.

FIG. 2B is an exploded perspective view of the modular button assembly shown in FIG. 2A.

FIG. 2C is an exploded, detailed, perspective view of a button cap assembly of the modular button assembly shown in FIG. 2B.

FIG. 3A is a disassembled and assembled perspective view of a modular button assembly including a button cap assembly and a button body assembly in accordance with some embodiments.

FIG. 3B is a disassembled and assembled perspective view of a modular button assembly including a button cap assembly and a button body assembly in accordance with some embodiments.

FIG. 4A is an exploded, perspective view of a button cap assembly in accordance with some embodiments.

FIG. 4B is an exploded, perspective view of a button cap assembly in accordance with some embodiments.

FIG. 5A is a front perspective view of keypads illustrating interchangeability of modular button assemblies in accordance with some embodiments.

FIG. 5B is a rear perspective view of the button assemblies of FIG. 5A.

FIG. 6 is illustrates keypads and diagrammatic connectivity with a computing system or user device for configuration of modular button assemblies and/or keypads based on user inputs in accordance with some embodiments.

FIG. 7 is a disassembled perspective view of a modular button assembly including a hard rocker feature in accordance with some embodiments.

FIG. 8 is an assembled perspective view of a modular button assembly including a hard rocker feature in accordance with some embodiments.

FIG. 9A is a perspective view of a foam insert of a modular button assembly in accordance with some embodiments.

FIG. 9B is a perspective view of a foam insert of a modular button assembly in accordance with some embodiments.

FIG. 10 is a rear perspective view of a modular button assembly in accordance with some embodiments.

FIG. 11A is a rear perspective view of a hinge assembly for a modular button assembly of FIG. 10 in accordance with some embodiments.

FIG. 11B is a front perspective view of a hinge assembly of FIG. 11A.

FIG. 12 is a side view of a modular button assembly in accordance with some embodiments.

FIG. 13A is a front perspective view of a modular button assembly in accordance with some embodiments.

FIG. 13B is a rear perspective view of a modular button assembly of FIG. 13A.

FIG. 14 is an exploded, perspective view of a button cap assembly in accordance with some embodiments.

### DETAILED DESCRIPTION

In conventional keypads, buttons are designed for a particular control functionality and typically remain at a fixed location on the keypad. The control functionality of the button is generally preprogrammed and usable to control, e.g., lighting, security, audio, visual, heating/cooling, or the like. Different buttons cannot be switched in terms of locations on the keypad and/or their control functionalities. If any of the buttons become damaged or require replacement, or if a different layout of the buttons on the keypad is desired, the entire keypad must be replaced.

In accordance with embodiments of the present disclosure, an exemplary modular reconfigurable keypad (referred to herein as “a keypad”) is provided that includes button assemblies that can be easily replaced and/or moved within the keypad while maintaining their functionality, such that modifications of the button layout in the keypad can be achieved. The keypad can include a modular button assembly having a plurality of modular buttons that can be configured with a digital signature and functionality such that the configuration follows a particular modular button, allowing different modular buttons to be moved to different locations within a control space in the keypad at any time with no loss of function and without resetting/reprograming the modular buttons. Thus, rather than having to replace the entire keypad or disassembly of multiple components, the keypad allows for each of the button assemblies to be independently removed from the keypad housing and inserted into either the same keypad housing or a different keypad house, while still maintaining the programmed functionality.

As used herein, a digital signature refers to a digital identifier (such as a serial number, or a series of unique strings) to uniquely identify a plurality of attributes of a modular button, such as a color, a text, a functionality controlled by the modular button, an operation performed by the modular button, or the like. In some embodiments, the digital signature can be stored in an electrically erasable programmable read-only memory (EEPROM), such as a local serial EEPROM, a serial peripheral interface (SPI) EEPROM, or other suitable EEPROM.

In some embodiments, information of the modular buttons (such as identifier, location, functionality, attributes, sensor data, light source control or other related information of one or more components of the modular buttons) can be pulled by a host to build as-built control strategy. For example, a computing device (e.g., a computer, a server, a mobile phone, a portable tablet, a processor, or the like) can access to the modular buttons and collect the information stored in a memory (e.g., EEPROM or other suitable memory) and/or database of the modular buttons and/or from sensors of the modular buttons. The computing device can further configure the modular buttons using the information of the modular button based on a user input (e.g., programming a particular modular button for a particular function before/after installation). The computing device can connect to the modular buttons in a wireless and/or wired manner to allow for programming each of the modular buttons for their respective functionality and/or digital signature.

In some embodiments, after initial system programming (e.g., programming for system initialization, such as initialization for modular buttons and/or other components of the keypad) before/after installation, a replacement and/or duplicate of a particular modular button can be added to the keypad without additional system programing. For example, the button can include a task identifier and/or serial number that is transmitted with the button action and allows the system to identify the physical location of the button within a facility (e.g., an environment in which the system is installed) and the specific button module being activated and/or requesting an action to take place. This allows the module to move anywhere within the system environment/facility without necessitating additional system programming or updates. This functionality also allows for duplication or replacement of the modular button without additional programming or system maintenance.

In some embodiments, a modular button surface can be skinned to adjust the industrial design by painting the surface and/or molding the surface. In some embodiments, the modular button surface can have a single part (e.g., a molded part or a painted part having a functionality identifier or a control system identifier). In some embodiments, the modular button surface can have a first part (e.g., a transparent or semitransparent part) covering a second part (e.g., a molded part or a painted part having a functionality identifier or a control system identifier).

In some embodiments, the modular buttons can be engraved (e.g., via molding or laser cutting) to identify module and specific point of control (e.g., with all detail included in the digital signature).

In some embodiments, the modular buttons can be in a multi-row configuration to support top or bottom justified text strings. In some embodiments, the modular buttons can be in a multi-row configuration to support top/bottom rocker (raise lower) functions and corresponding text strings. In some embodiments, a modular button can include one or more push buttons to perform a single action, toggling, horizontal or vertical rocking. In some embodiments, a modular button can include one or more light-emitting diodes (LED), e.g., RGBW LED or other suitable LEDS. In some embodiments, a modular button can determine whether it is at an occupancy state or at a vacancy state. In some embodiments, a modular button can include a plurality of sensors, such as environmental or air quality sensors, pressure sensors, or other suitable sensors. In some embodiments, a modular button can include microphone for detection or voice control.

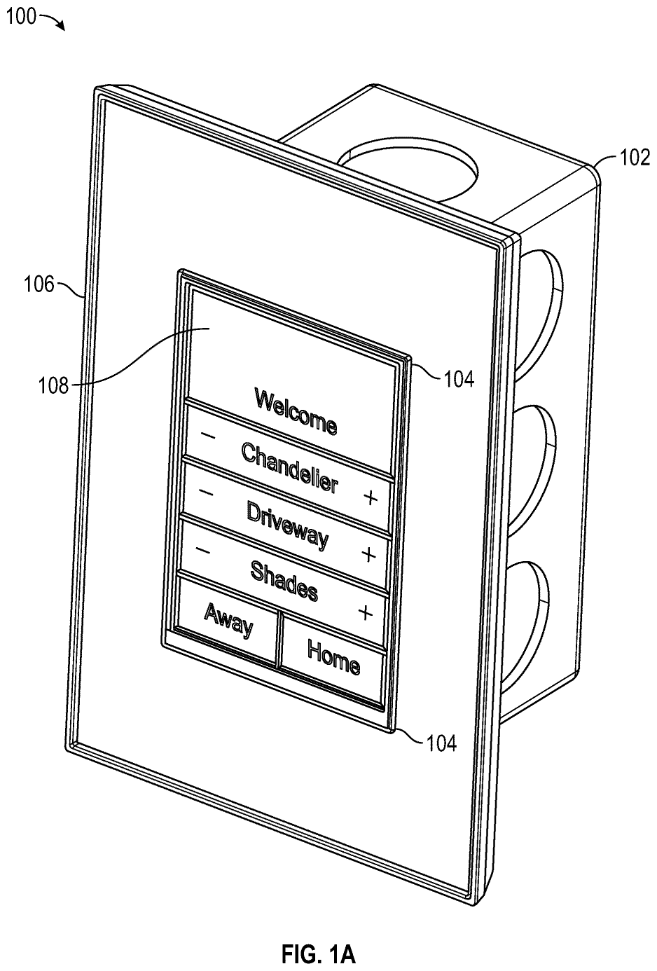

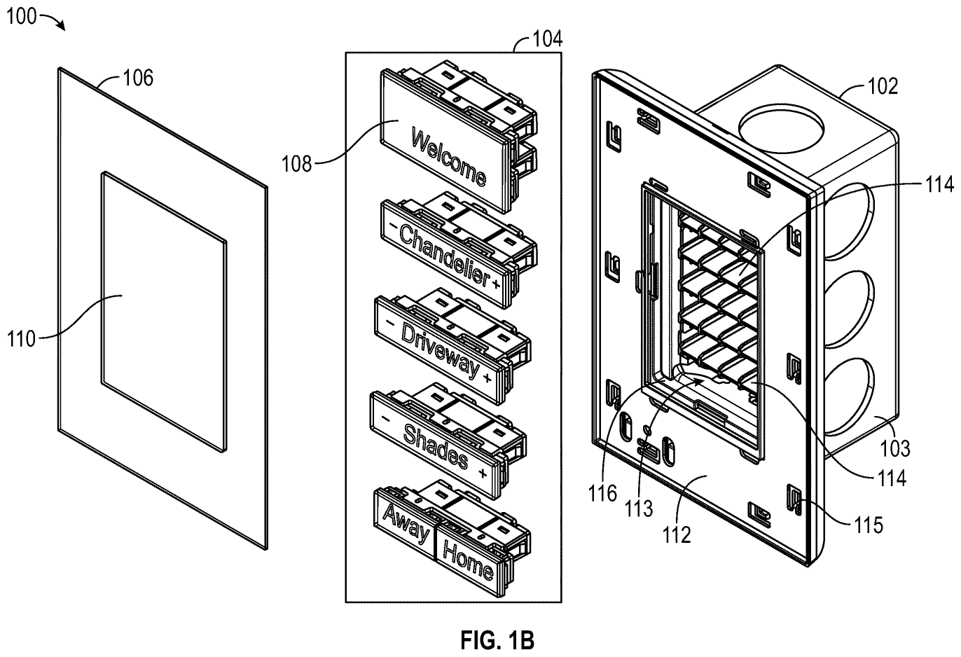

FIG. 1A is a perspective view of a modular reconfigurable keypad 100 (hereinafter “keypad 100”) in accordance with some embodiments. FIG. 1B is an exploded perspective view of the keypad 100 shown in FIG. 1A. The keypad 100 can be a primary control point for automation systems used in areas such as homes, businesses, boats, yachts, motor homes and busses. It should be understood that the keypad 100 can be used in other environments within the scope of the present disclosure. Other such environments include calculators, telephones, and office equipment, for example.

The keypad 100 includes a housing assembly 102 capable of receiving a grouping or array 104 of modular button assemblies 108. The button assemblies 108 can be selectively positioned at least partially within the housing assembly 102, and can be selectively moved and/or reconfigured within the housing assembly 102 based on the needs of the user. The keypad 100 includes a faceplate 106 removably secured to a front surface of the housing assembly 102 (e.g., via a snap fit).

The housing assembly 102 can include and protect electrical circuitry that can be electrically coupled to each of the button assemblies 108 when the button assemblies 108 are inserted into the housing assembly 102. The electrical circuitry can include one or more electrical boards that can electrically connect each of the button assemblies 108 to different systems (e.g., a lighting system, a security system, an audio visual system, a heating system, a cooling system or the like) such that actuation of each of the button assemblies 108 can be used to control a specific system functionality. The electrical circuitry can be housed within a rear section 103 of the housing assembly 102 defining the distal end of the housing assembly 102. The rear section 103 can be configured for installation within a wall such that the faceplate 106 of the keypad 100 is flush or substantially flush with the outer wall surface.

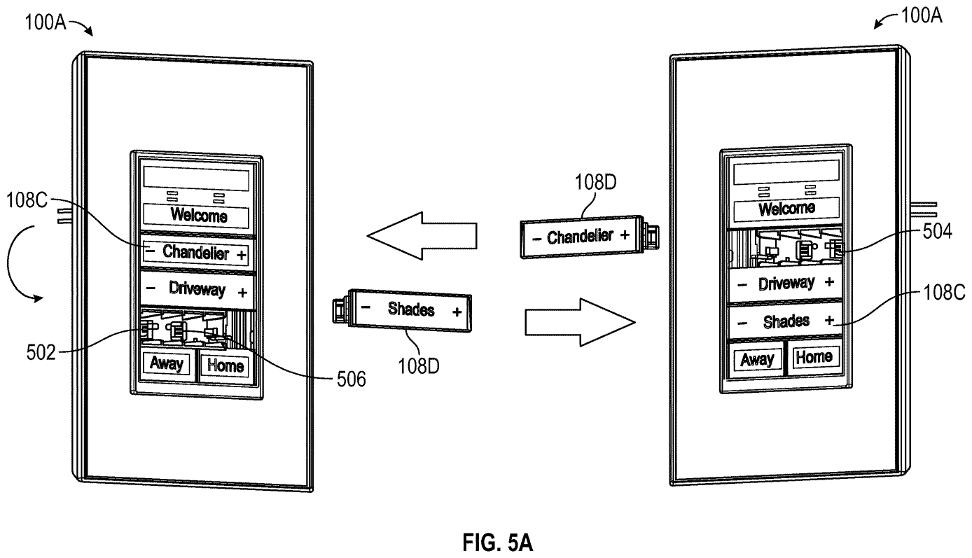

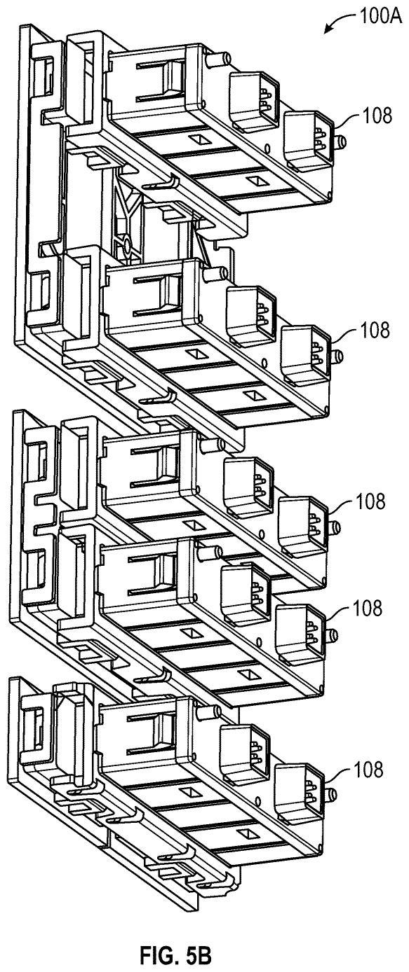

The housing assembly 102 includes a front plate 112 at a proximal end of the housing assembly 102 to allow for installation of the housing assembly 102 to the outer surface of the wall. The front plate 112 includes a central, rectangular opening 116 leading into a control space 113 of the housing assembly 102. The control space 113 includes rows of recessed potions 114 each configured to removably receive one or more button assemblies 108. The recessed portion 114 includes multiple electrical contacts (e.g., contacts 506 illustrated in FIG. 5) capable of electrically coupling with electrical contacts 201 of the button assemblies 108 such that insertion of the button assembly 108 into the recessed portion 114 electrically couples the electrical circuitry of the housing assembly 102 to the electrical contacts 201 (and thereby the internal electrical circuitry) of the button assembly 108. The outward facing surface of the front plate 112 can include multiple attachment features 115 capable of receiving complementary features on the rear surface of the faceplate 106 such that the faceplate 106 can be removably attached to the front plate 112, e.g., via a snap fit, or the like. The front plate 112 includes an opening 116 that matches and aligns with an opening 110 of the faceplate 106 when the faceplate 106 is secured to the front surface of the front plate 112. The openings 110, 116 are sized and shaped to accommodate insertion and removal of different combinations of the modular button assemblies 108.

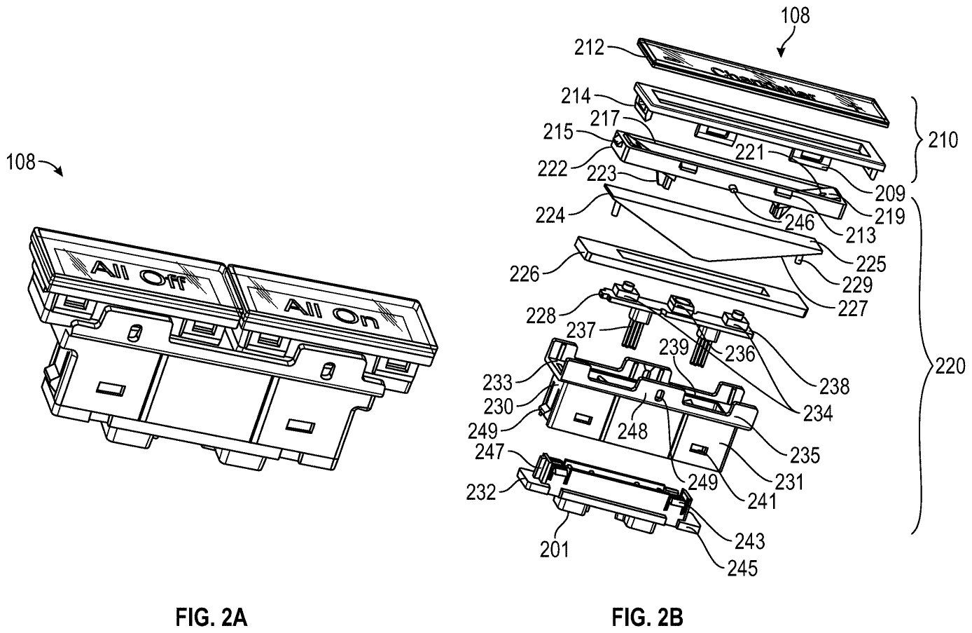

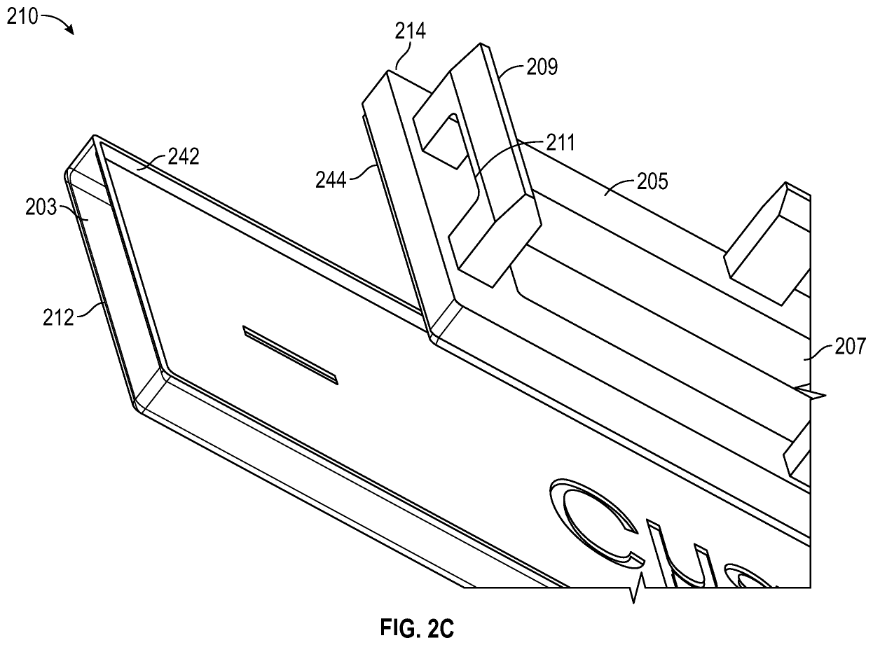

Each of the button assemblies 108 which can be selectively depressed to actuate a specific function of the button assembly 108, thereby controlling systems such as lighting, security, audio visual and heating/cooling, for example. In some embodiments, the button assembly 108 can have a single on/off functionality, with one depression of the button assembly 108 turning the functionality “on” and another depression of the button assembly 108 turning the functionality “off”. In some embodiments, the button assembly 108 can have multiple functionalities, e.g., with +/− symbols on opposing sides to allow for gradual operation of the system. The ends of the button assembly 108 can therefore be depressed multiple times to perform a certain functionality,. e.g., increasing or decreasing the temperature when controlling a heating/cooling system. The button assembly 108 can be connected to the electronic circuitry contained in the housing assembly 102. Different button assemblies 108 can be switchable between different locations in the control space 113 based on the layout desired by the user, with the movable button assemblies 108 maintaining their programmed functionality (until the functionality is reprogrammed by the user). A detailed construction of the button assemblies 108 is described with respect to FIGS. 2-4.

FIG. 2A is a perspective view of a modular button assembly 108 in accordance with some embodiments, FIG. 2B is an exploded perspective view of the modular button assembly 108 shown in FIG. 2A, and FIG. 2C is an exploded perspective view of a portion of a button cap assembly 210 for the modular button assembly 108 shown in FIG. 2B. The button assembly 108 includes a button cap assembly 210 and a button body assembly 220. The button cap assembly 210 can be removably attached, connected, or mounted to the button body assembly 220, such that the button cap assembly 210 can be interchanged as needed by the user.

The button cap assembly 210 can include a top plate 212 and a mounting plate 214. The top plate 212 can be mounted to or coupled with the mounting plate 214. In some embodiments, the button cap assembly 210 can be molded in acrylic/polycarbonates material. The top plate 212 can be customized to include any type of text indicating the intended functionality of the button assembly 108. The top plate 212 can be replaced or interchanged to change the text on the top plate 212 visible to the user. As illustrated in FIG. 2C, the top plate 212 includes a perimeter flange or edge 203, the inner surface of which includes a locating ring 242 extending along the entire perimeter of the inner surface. The locating ring 242 can be in the form of a thin extension protruding partially out of the inner surface of the edge 203.

The mounting plate 214 includes a substantially rectangular body 205 dimensioned complementary to the inner surface area defined within the confines of the edge 203 of the top plate 212, such that the locating ring 242 can be at least partially inserted into and snapped together with the top plate 212. The front or top facing surface of the top plate 212 can include a locating ring 244 along its edge such that the locating ring 242 can be connected/coupled/mounted to the mounting plate 214 via the locating ring 244. In some embodiments, the locating ring 244 can be in the form of a thin extension protruding partially along the front edge of the mounting plate 214. In some embodiments, the locating ring 244 can be in the form of an inwardly directed groove formed along the front edge or side of the mounting plate 214, with the groove dimensioned complementary to the locating ring 242 of the top plate 212 such that snapping of the locating ring 242 into the groove engages and/or couples the top plate 212 with the mounting plate 214. In some embodiments, adhesive or glue can be used for assembly of the top plate 212 and the mounting plate 214. The locating ring 242 can assist in eliminating the need for an assembly fixture to position the two parts during the assembly process, e.g., the locating ring 242 ensures alignment of the mating parts to maintain the gaps between the button and the button to frame. The assembly of the top plate 212 with the mounting plate 214 can thereby be achieved without the use of traditional methods, such as glue. The locating rings 242, 244 assist with alignment of the component relative to each other, overcoming misalignment issues traditionally found in laser cut glass assemblies due to dimensional inconsistencies.

As illustrated in FIG. 2C, the mounting plate 214 includes a central opening 207 formed in the body 205. The opening 207 can define a substantially rectangular shape and can allow for light to pass therethrough from one or more LEDs located internally within the button assembly 108. The top plate 212 can thereby be at least partially illuminated through the opening 207 for visibility of the button and any text engraved on the top plate 212. The rear surface of the body 206 includes multiple engagement features extending therefrom. The engagement features can include U-shaped extensions 209 with a central opening 211 configured and dimensioned to receive complementary snap features 213 (e.g., protrusion) of a mounting base 222.

The button body assembly 220 can include a mounting base 222 coupled to the mounting plate 214. The assembly 220 can include a light diffuser 224, a foam 226, an electrical assembly 228, an inner housing 230, and a base plate 232. The mounting base 222 includes a body 215 defining a substantially rectangular configuration complementary to the mounting plate 214. The outer surface of the body 215 includes the snap features 213 (e.g., hook-like features) extending from the outer surface in a spaced manner. The snap features 213 can be located in an aligned manner with the extensions 209 of the mounting plate 214 to allow for the mounting plate 214 to be releasably engaged with the mounting base 222. In the engaged configuration, the mounting plate 214 can sit on top of and against the top surface of the mounting base 222.

The mounting base 222 includes an opening 217 formed in the top surface and extending inwardly into the body 215 of the mounting base 222. The body 215 includes downwardly tapered inner walls 219 that extend from side edges downwardly towards a central point. The tapered inner walls 219 and the planar/perpendicular side walls within the opening 217 define a hollow interior configured to at least partially receive the light diffuser 224. The inner walls 219 can include openings 221 extending perpendicularly therethrough for alignment of the light diffuser 224 with the mounting base 222 during assembly. The bottom surface or wall of the mounting base 222 includes extensions 223 for functionality actuation of the electrical assembly 228. Coupling of the mounting base 222 to the mounting plate 214 results in the button cap assembly 210 being mounted to the mounting base 222. If replacement or changing of the button cap assembly 210 is desired, the button cap assembly 210 can be easily disengaged from the mounting base 222 to allow for replacement of the top plate 212. The side surfaces of the base 222 include extensions 246 on opposing sides configured to engage with and lock relative to the inner housing 230. The extensions 246 can be in the form of a circular pin or cylinder protruding from the side surface.

The light diffuser 224 defines a body with a substantially rectangular configuration, including a top planar surface 225 and tapered bottom surfaces 227 that extend towards each other at a central bottom point. The light diffuser 224 includes alignment posts 229 extending perpendicularly (e.g., aligned with a central longitudinal axis of the assembly 108) from the bottom surfaces 227. The position of the posts 229 is complementary to the openings 221 in the mounting base 222, such that the posts 229 can be aligned with and inserted into the openings 221 to assemble the light diffuser 224 with the mounting base 222. In the assembled configuration, the top surface 225 of the light diffuser 224 can be substantially aligned with the top surface of the mounting base 222 to allow for coupling of the mounting plate 214 over the light diffuser 224. The light diffuser 224 can diffuse light emitted from LED(s) 236 included in the electrical assembly 228, with the diffused light passing through the opening in the mounting plate 214 for illumination of the top plate 212.

The foam 226 can define a substantially rectangular configuration and can be located between the light diffuser 224 and the electrical assembly 228. For example, in the assembled configuration, the bottommost point of the light diffuser 224 can be positioned above a plane defined by the bottommost point of the extensions 223 of the mount base 222. The foam 226 can be used to ensure uniform level positioning of the components when the switch is at rest. In some embodiments, the foam 226 can be disposed adjacent to the extensions 223 to provide at least some tactile feeling to the user during actuation of the button assembly 108. In some embodiments, the foam 226 can include a cutout to allow for passage of light from the LED(s) 236 to the light diffuser 224.

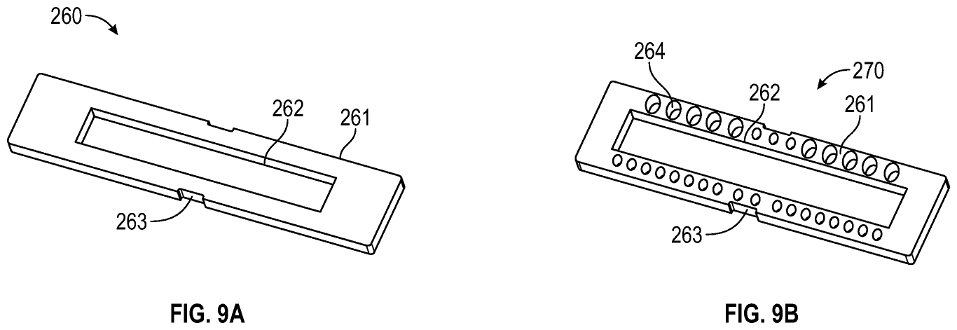

For example, FIGS. 9A and 9B are perspective views of foam 260, 270 that could be used in the assembly instead of foam 226. The foam 260, 270 can define a generally rectangular, planar body 261 with a central rectangular cutout 262 configured to fit at least partially around the LEDs 236 of the light diffuser 224. The perimeter of the foam 260, 270 can include one or more cutouts or grooves 263 to assist with positioning of the foam 260, 270 in the assembly. In some embodiments, the foam 270 can include perforations 264 formed therein to reduce the hardness of the foam 270 in specific areas along the perimeter of the foam 270. The perforations 264 can be adjusted or localized to reduce the hardness of specific areas. For example, as illustrated in FIG. 9B, perforations 264 in the top and bottom edges on a multi-row switch allow the foam 270 to be softer than the outside edges. However, other areas of the foam 264 may be selectively perforated to regulate the hardness for the desired feel of the button. In addition, the size of the perforations 264 can be varied to create the desired hardness in the foam 270.

The electrical assembly 228 includes an electrical circuit board 238 with the LED(s) 236 mounted thereon. In some embodiments, the position of the LED(s) 236 can be aligned with the bottommost point of the light diffuser 224 to ensure uniform diffusion of light. In some embodiments, the LED(s) 236 can be side-fired to light the diffuser 224 from the side, thereby reducing the overall assembly depth. In such embodiments, alignment of the LED(s) 236 with the bottom of the diffuser 224 would not be necessary. One or more tactile push buttons 234 can be mounted to the board 238 and aligned with the extensions 223 of the mounting base 222. For a button assembly 108 with a single functionality (e.g., on/off), only a single push button 234 can be used with a single extension 223. For a button assembly 108 with multiple functionalities (e.g., up or down adjustment of temperature or volume), two or more push buttons 234 can be used with a complementary number of extensions 223. The tactile push buttons 234 can be selected to perform a single action, toggling, horizontal rocking, or vertical rocking. The functional control associated with each push button 234 can be programmed into the circuit board 238 by the user through a wired and/or wireless connection with a computing device. Due to the inclusion of the circuit board 238 within the button assembly 108, the functionality programmed into and associated with the button assembly 108 remains with the button assembly 108 when it is removed from the housing assembly 102. The electrical assembly 228 includes electrical contacts 237 coupled to the circuit board 238 and extending from the bottom surface of the circuit board 238.

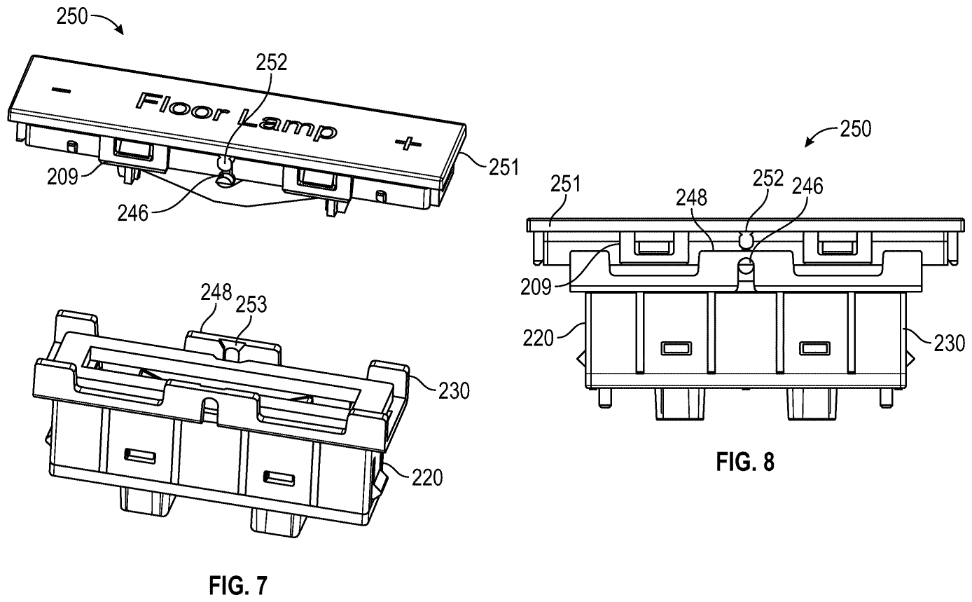

The housing 230 includes a body with a lower section 231 with a top plate or surface 233, and side flanges 235 extending upwardly/perpendicularly from the top surface 233 on opposing sides of the housing 230. The housing 230 includes four planar flanges 235 disposed at each of the corners of the top surface 233. The housing 230 includes central, planar flanges 248 located between the flanges 235 and disposed on opposing sides from each other. The flanges 248 include an elongated vertical slot 249 formed therein. During assembly of the button, the extensions 246 of the base 222 snap into the slots 249 to maintain the base 222 (and associated components) engaged with the housing 230. In some embodiments, the inner surface of the flange 248 can include a tapered groove 253 configured to guide the extension 246 into the slot 249 (see, e.g., FIG. 7). Due to the elongated nature of the slot 249, the base 222 (and associated components) is capable of moving/sliding vertically relative to the housing 230, with the top and bottom edges of the slot 249 acting as stops for movement of the extensions 246. The top surface 233 includes openings 239 formed therein and extending the height of the housing 230. During assembly, the electrical contacts 237 of the circuit board 238 extend through the openings 239 and from the end of the button assembly 108 to allow for electrical coupling of the button assembly 108 to electrical contacts within the housing assembly 102. The flanges 235 at least partially surround and support the assembly of components of the button assembly 108, e.g., top plate 212, mounting plate 214, mounting base 222, diffuser 224, and foam 226.

The housing 230 includes openings 241 formed in the side walls and configured to engage with snap features 243 of the base plate 232 when the housing 230 and base plate 232 are assembled with each other. The base plate 232 can include a central flange 245 with an upper structure 247 extending from one end and electrical contacts 201 extending from the opposing end. During assembly, the upper structure 247 is configured to be inserted into and received by the hollow interior of the housing 230 such that the snap features 243 engage with the openings 241 of the housing 230, thereby releasably locking the housing 230 with the base plate 232. The electrical contacts 237 electrically connect with or extend through the electrical contacts 201 of the base plate 232, allowing for electrical coupling of the button assembly 108 with the electrical contacts within the housing assembly 102. The side walls of the housing 230 include flexible engagement features 249 (e.g., snap hook-like extensions, or the like) that releasably lock the button assembly 108 within the recessed portions of the housing assembly 102 control space 113.

The electrical assembly 228 can further include a digital signature and an EEPROM. The digital signature can include a serial number and a plurality of attributes of a modular button, such as a color, a text, a functionality controlled by the modular button, an operation performed by the modular button, or the like. In some embodiments, the digital signature can be stored in the EEPROM, such as local serial EEPROM, SPI EEPROM, or other suitable EEPROM.

In some embodiments, the electrical assembly 228 can be programmed to determine whether the button assembly 108 is at an occupancy state or at a vacancy state. In some embodiments, the electrical assembly 228 can include a plurality of sensors (e.g., mounted to the circuit board 238), such as environmental or air quality sensors, pressure sensors, or other suitable sensors. In some embodiments, the electrical assembly 228 can include microphone (e.g., mounted to the circuit board 238) for detection or voice control.

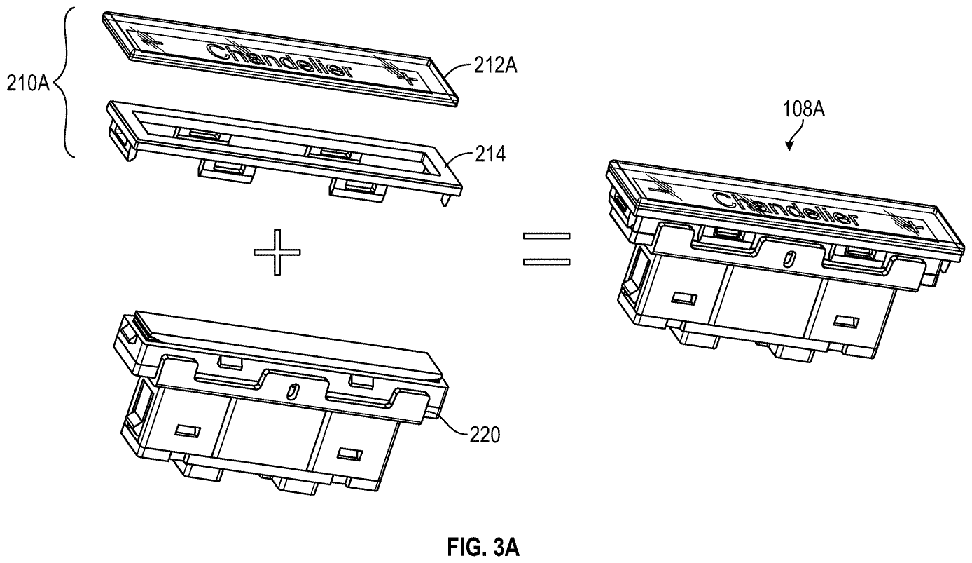

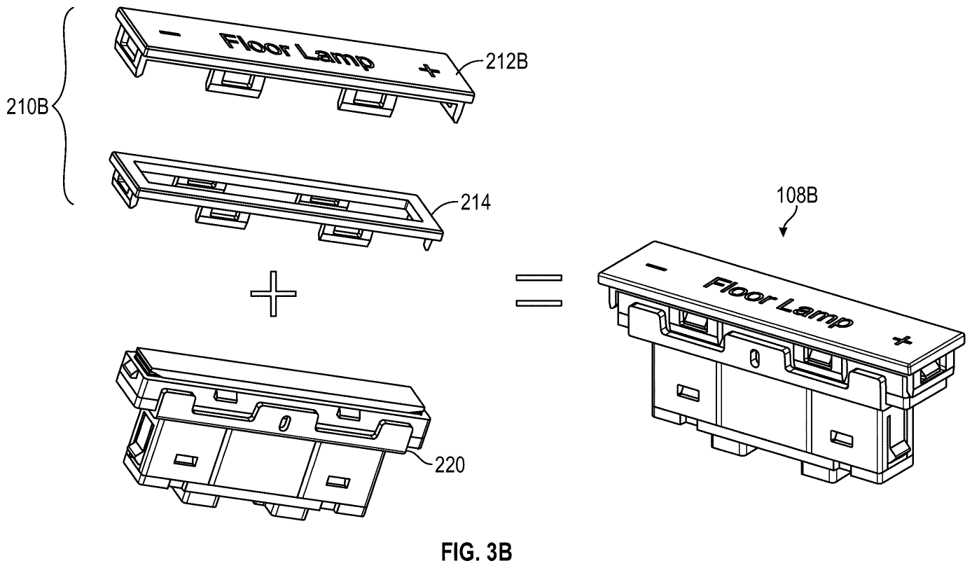

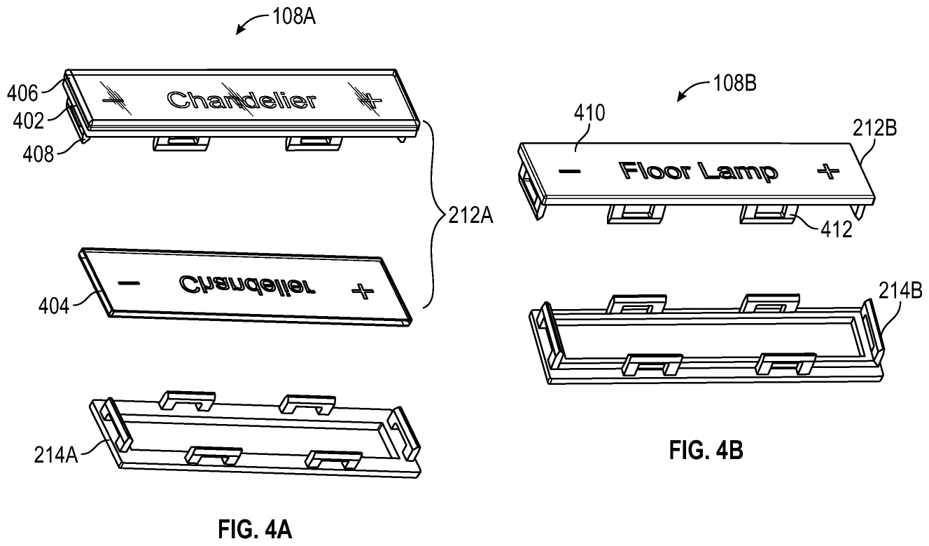

FIG. 3A is a disassembled and assembled view of an example modular button assembly 108A having a button cap assembly 210A and a button body assembly 220 in accordance with some embodiments. The button cap assembly 210A has a top plate 212A and the mounting plate 214. The button cap assembly 210A can be mounted with the button body assembly 220. In some embodiments, the top plate 212A can include two parts as further described in FIG. 4A.

FIG. 3B is a disassembled and assembled view of an example modular button assembly 108B having a button cap assembly 210B and a button body assembly 220 in accordance with some embodiments. The button cap assembly 210B has a top plate 212B and the mounting plate 214. The button cap assembly 210B can be mounted with the button body assembly 220. In some embodiments, the top plate 212B can be a single piece as further described in FIG. 4B. As illustrated in FIGS. 3A and 3B, the button cap assemblies 210A, 210B can be removed from the remaining assembly 108A, 108B to allow for changing of the text visible on the outermost surface of the assembly 108A, 108B. The button assembly 108A, 108B can therefore be easily customized without disassembly of the entire button assembly 108A, 108B, and the button assembly 108A, 108B can be moved and reinstalled in the same or different housing assembly 102 without altering the functionality of the button assembly 108A, 108B.

FIG. 4A is an exploded perspective view of the button cap assembly 108A in accordance with some embodiments. The button cap assembly 108A includes a top plate 212A and a mounting plate 214A. The top plate 212A can be mounted onto the mounting plate 214A. The top plate 212A has a first part 402 and a second part 404. The first part 402 can have a top surface plate 406 (e.g., a transparent plate), and a mounting portion 408. The top surface plate 406 can be mounted on the mounting portion 408. The second part 404 can be an identifier plate having an identifier (e.g., a name, text, or the like) via surface painting or engraving technique to identify a functionality/system controlled by a modular button. The identifier can have unique attributes (e.g., color, text, or the like). The top plate 212A can therefore be formed form multiple components that are assembly before further assembly with the mounting plate 214A. If customization or changing of the identifier is desired, the top plate 212A can be disassembled and the second part 404 can be replaced as needed.

FIG. 4B is an exploded perspective view of the button cap assembly 108B in accordance with some embodiments. The button cap assembly 108B includes a top plate 212B and a mounting plate 214B. The top plate 212B can be mounted onto the mounting plate 214B. The top plate 212B is a single piece having a surface 410 on the top and a mounting portion 412 at the bottom. The surface 410 can be painted or engraved to have an identifier. In some embodiments, the top plate 212B can be fabricated as a single, unitary structure that includes the identifier on the outermost surface, and the features of the mounting plate on the opposing side, thereby acting as a combination of a top plate and a mounting plate (e.g., no additional mounting plate 214B is needed for attachment to the remaining button assembly 108B).

In some embodiments, the button assembly can be customized by the user to select if the button is to have a hard rocking functionality or a soft rocking functionality. For example, FIGS. 7 and 8 are disassembled and assembled views of a modular button assembly 250 that is substantially similar in structure and function to the assembly 108, except for the distinctions noted herein. Thus, the same reference numbers refer to the same structures. In the assembly 250, the bottom edge of the mounting plate 251 can include a removable tab 252 disposed between the extensions 209. The tab 252 can be in the form of a circular (or substantially circular) extension with a rounded bottom surface configured to engage with or be positioned against the top edge of the flange 248.

If the tab 252 remains in place, after assembly, the center of the button remains hard and no button activation takes place if the button center is pressed by the user (e.g., pushing down on the center of the button does not move the button downward). In particular, engagement of the bottom of the tab 252 with the top of the flange 248 prevents any downward motion of the button, while allowing for pivoting of the button to the right or left as the bottom of the tab 252 allows for rolling side-to-side against the flange 248. The button is therefore capable of rocking back and forth to allow for left and right actuation. The tab 252 can be removed by, e.g., snapping, twisting or breaking the tab 252 off of the mounting plate 251, and discarded. With the tab 252 removed, after assembly, the button activates in a soft rocking operation due to the lack of interference with the top of the flange 248. The left and right pivoting/actions of the button remain. However, pressing the center of the button allows for activation of both buttons simultaneously (due to downward motion of the button), or can provide a different actuation function. Additional modularity in actuation is thereby provided by the removable tab 252.

FIGS. 5A and 5B are front and rear diagrams illustrating that different modular button assemblies 108 can be switched to different locations in the control space 113 in accordance with some embodiments. For example, the modular button assembly 108D can be moved out from a recessed portion 502 in the fourth row and the modular button assembly 108C can be moved out from a recessed portion 504 in the second row and can be inserted into the recessed portion 502 in the fourth row. The modular button assembly 108D can be inserted into the recessed portion 504 in the second row. The electrical contacts 506 within the recessed portions 502, 504 electrically couple with the complementary electrical contacts of the respective button assemblies 108 upon insertion of the button assemblies into the recessed portions 502, 504. Because each button assembly 108 includes the programmed circuitry within the button assembly 108, the configuration (e.g., programming to perform a particular function) of each button follows each button regardless of the location change of each button. For example, a button programmed to increase or decrease a temperature of a heating/cooling system maintains the same functionality even if it is moved from one housing assembly to another, or moved from one position in a housing assembly to another position in the same housing assembly. After the location is changed, because the internal configuration/programming of the modular button does not change, the modular button can perform the same operation and control the same system as before. The keypad 100A can be automatically updated as soon as the button positions are changed. The button assemblies can therefore be interchanged and/or mixed/matched into customized configurations based on the needs of the user without affecting the underlying functionality of the button assembly.

As illustrated in FIGS. 5A and 5B, the assemblies 108 can be grouped into single or multi-row module structures. For example, the button cap assembly associated with the assemblies 108 can be configured and dimensioned to receive one, two or more modules. As shown in FIG. 5B, the upper module structure can receive two assemblies 108 spaced from each other by a gap. The central module structure can receive two assemblies 108 positioned adjacent to each other. The lower module structure can receive a single assembly 108. In some embodiments, the multi-row modules may be different than a single row module to reduce the force needed for activation. The multi-row modules are composed of a single assembly 108 placed at the top and bottom of the module.

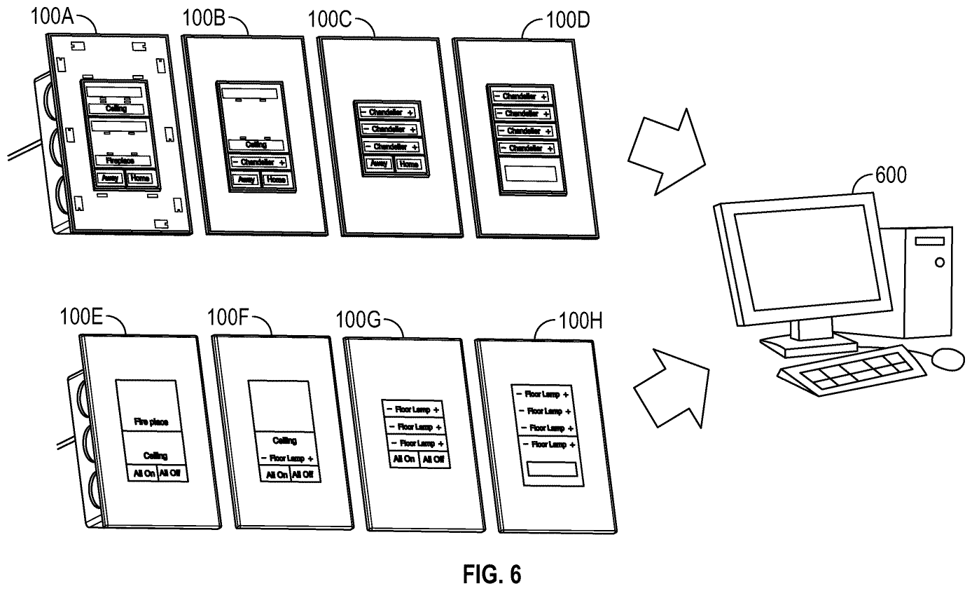

FIG. 6 is an diagram illustrating multiple keypads 100A-100H and their connectivity with a computing device 600 for programming of the modular button assemblies. The computing device 600 (e.g., a computer, a server, a mobile phone, a portable tablet, a processor, or the like) can electronically access the keypad 100A-100H through wired and/or wireless means, and collects the information stored in a memory (e.g., EEPROM or other suitable memory) and/or database of the button assemblies 108 and/or information from sensors or other components of the button assemblies 108, and information from other components (e.g., the housing assembly 102). The computing device 600 can be used to configure/program the modular button assemblies 108 and/or the housing assembly 120 using the above information based on a user input (e.g., programming a particular modular button for a particular function before/after installation). In some embodiments, after initial system programming (e.g., programming for system initialization, such as initialization for modular buttons and/or other components of the keypad 100) before/after installation, a replacement and/or duplicate of a particular modular button 108 can be added to the keypad 100 without additional system programing.

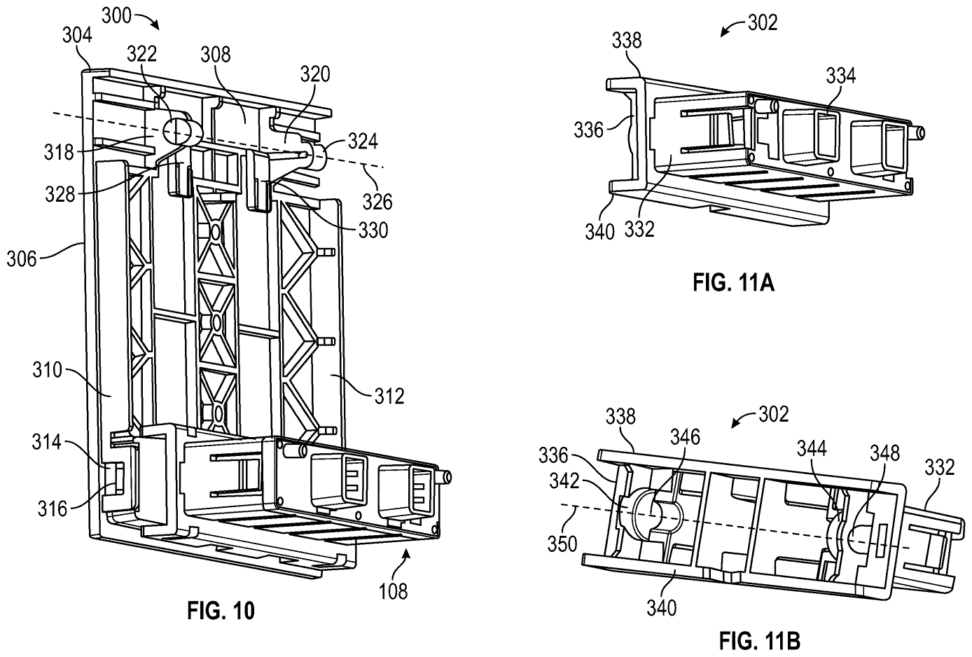

In some embodiments, the button body assembly (e.g., button body assembly 220) can be fixedly coupled to the rear surface of the mounting plate (e.g., mounting plate 251 and/or top plate 212) of the modular button assembly (see, e.g., FIG. 5B). In each instance of the modular button assemblies in FIG. 5B, including the larger button assembly at the top of FIG. 5B, the button body assemblies are fixedly coupled to the mounting plate. In some embodiments, the assembly can include a button body assembly fixedly coupled to one end of the mounting plate and a hinge assembly pivotably coupled to another end of the mounting plate (e.g., the front facing button component of the assembly). For example, FIG. 10 illustrates a rear perspective view of a partial modular button assembly 300, and FIGS. 11A and 11B illustrate rear and perspective views of a hinge assembly 302 configured to be hingedly coupled to the button assembly 300.

The button assembly 300 includes a mounting plate 304 with a front surface 306 configured to face the user and to be physically engaged by the user, and an opposing rear surface 308. The rear surface 308 can include two flanges 310, 312 extending from opposing sides and both including an opening 314 configured to receive and engage with a flange 316 of a button assembly 108. This snapping engagement between the flange 316 and the opening 314 allows for a fixed (releasable) coupling between the button assembly 108 and the mounting plate 304.

At or near the top of the rear surface 308, the mounting plate 304 includes two flanges 318, 320 extending perpendicularly therefrom. Each flange 318, 320 includes a mounting post 322, 324 extending outwardly and perpendicularly from the side surface of the respective flange 318, 320. The posts 322, 324 can be substantially cylindrical in configuration. The posts 322, 324 are aligned along a pivot axis 326 along which the hinge assembly 302 of FIGS. 11A and 11B can at least partially rotate. Immediately adjacent to the flanges 318, 320 and between the flanges 318, 320, the mounting plate 304 can include indented areas or grooves 328, 330 configured to receive a spring (not shown). The spring can be a weak compression spring configured to prevent rotation of the hinge assembly 302 relative to the mounting plate 304 at rest, thereby allowing the hinge assembly 302 to be plugged in or assembled with the mounting plate 304. For alignment (neutral position) during assembly, the spring can be molded into the button (e.g., at the grooves 328, 330) to ensure that the module sits at the right angle to ensure module alignment during field installation. The spring size/strength can be adjusted to the individual button needs as the button size varies, for example.

With reference to FIGS. 11A and 11B, the hinge assembly 302 can be similar in structure to the module or assembly 108. However, rather than including a button that can be actuated by the user, the hinge assembly 302 only serves the purpose of providing a pivoting interface for the mounting plate 304 about axis 326. The hinge assembly 302 includes a housing 332 that is substantially similar in structure to the housing 230 of FIG. 2B. In this manner, the hinge assembly 302 is intended to fit within the same volume or space as the button assembly 108. The rear or distal end of the housing 332 includes projections 334 without any electrical contacts therein. However, the projections 334 allow for non-electrical coupling with complementary structures within the housing assembly 102 (e.g., while the electrical contacts 201 of the base plate 232 of the button assembly 108 electrically engage with electrical contacts within the housing assembly 102).

The front or proximal end of the housing 332 includes a top plate 336 with flanges 338, 340 extending perpendicularly on opposing sides of the top plate 336. Extending perpendicularly from the top plate 336, the housing 332 includes hinge projections 342, 344 that each include inwardly facing cutouts or grooves 346, 348. The grooves 346, 348 face each other and define a substantially circular or oval configuration with a diameter or width complementary to the diameter of the posts 322, 324 of the mounting plate 304. The grooves 346, 348 define a pivot axis 350. During assembly, the hinge projections 342, 344 can be flexed or snapped around the posts 322, 324 such that the posts 322, 324 at least partially fit within the grooves 346, 348, thereby substantially aligning the axes 326, 350. Such engagement allows the hinge assembly 302 to pivot relative to the mounting plate 304.

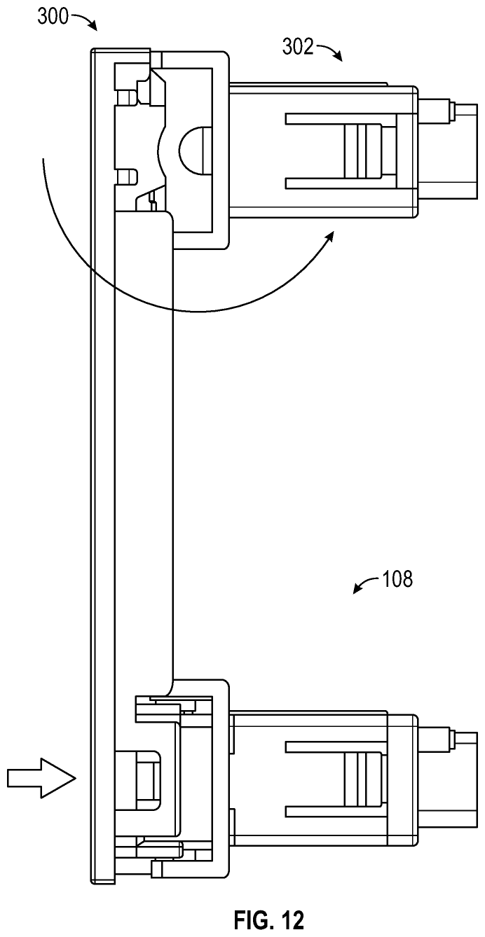

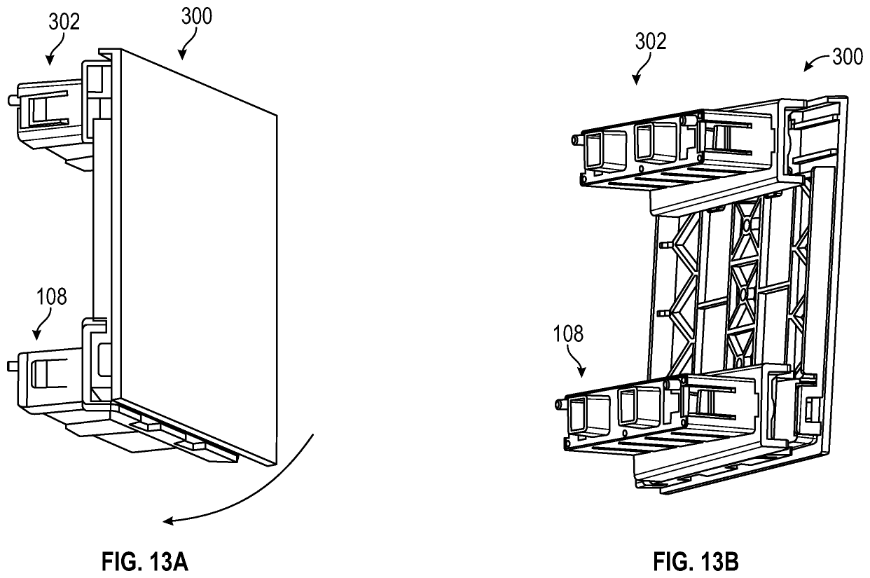

FIG. 12 is a side view of the modular button assembly 300 with the hinge assembly 302 pivotably coupled to the mounting plate 304 and the button assembly 108 fixedly coupled to the mounting plate 304. As indicated by the arrow in FIG. 12, pivoting of the mounting plate 304 is permitted with the hinge assembly 302 arrangement. FIGS. 13A and 13B are front and rear perspective views of the modular button assembly 300. In use, the user can actuate the button by applying force to the front surface of the mounting plate 304 at or near the text, which is aligned with the button assembly 108. Applying force at the top of the mounting plate 304 at or near alignment with the hinge assembly 302 would not actuate the button assembly 108. The button assembly 300 can thereby combine the modular aspect of the modules/buttons discussed herein with the pivoting ability of the mounting plate. Such hinging ability can assist with installation of the button assembly 300 into the housing assembly 102. The hinge can, e.g., reduce the number of buttons, reduce the force needed to activate the switch, provide consistency in movement and/or activation, combinations thereof, or the like.

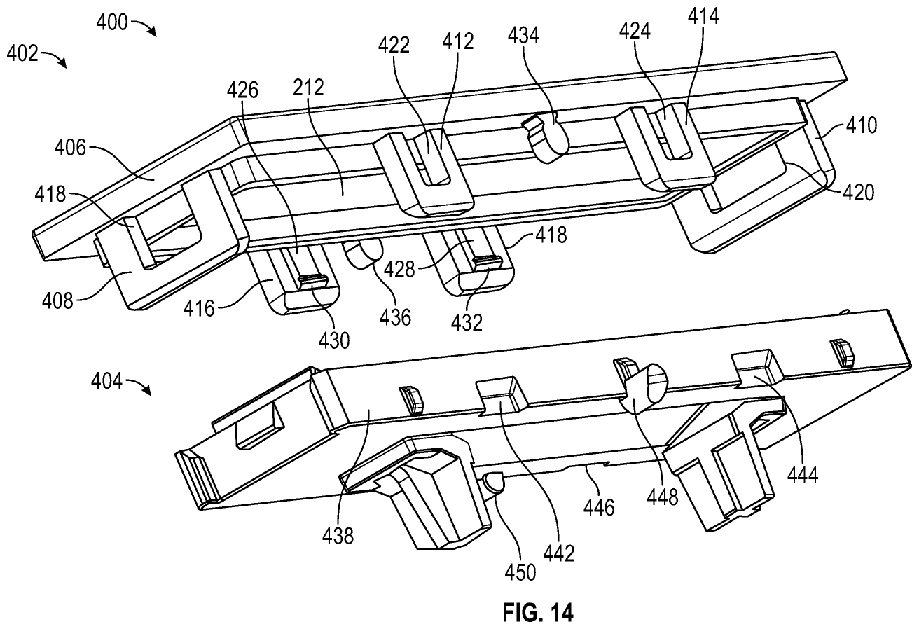

FIG. 14 is an exploded view of a button cap assembly 400. The button cap assembly 400 can be substantially similar to the button cap assembly 210 of FIG. 2B, except for the distinctions noted herein. The assembly 400 includes a mounting plate 402 configured to releasably engage with a mounting base 404 to retain a top plate 212. As discussed herein, the releasable engagement between the mounting base 404 and the mounting plate 402 allows the top plate 212 to be easily updated/replaced without breakage and discarding of one or more components of the assembly 400.

The mounting plate 402 includes a body 406 with flanges or extensions 408-416 extending perpendicularly from the body 406. The mounting plate 402 can include extensions 408, 410 on opposing side edges of the body 406, and pairs of extensions 412, 414 and extensions 416, 418 on opposing top and bottom edges of the body 406. Each extension 408-416 can be substantially U-shaped with an opening 418-428. The openings 418, 420 are configured to engage via a snap fit with a complementary protrusion/edge of the mounting base 404. On an inner facing surface at the distal end of the extensions 412, 414, 416, 418, the mounting plate 402 can include projections 430, 432 configured to engage via a snap fit with complementary grooves/edges of the mounting base 404. The mounting plate 402 can include extensions 434, 436 on opposing sides that are substantially similar to the extension 246 of FIG. 2B for pivoting action of the module.

The mounting base 404 includes a body 438 with flanges or projections 440 on opposing sides of the body 438. The projections 440 are configured to be at least partially received within the openings 418, 420 of the extensions 408, 410 to releasably engage the mounting plate 402 with the mounting base 404. The mounting base 404 includes grooves 442-446 formed in pairs on opposing top and bottom edges of the body 438. The grooves 442-446 are configured to at least partially receive the projections 430, 432 of the extensions 412-418 to releasably engage the mounting plate 402 with the mounting base 404. The mounting base 404 also includes central projections or extensions 448, 450 configured to engage with the extensions 434, 436 for pivoting action of the module. The snapping engagement between the mounting plate 402 and the mounting base 404 allows for a releasable configuration for replacement of the top plate 212 without necessitating breakage and discarding of components.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A modular button assembly, comprising:
a button cap; and
a button body assembly releasably coupled to the button cap, the button body assembly including:
a circuit board programmable with functionality of the modular button assembly;
one or more buttons coupled to the circuit board for controlling the functionality of the modular button assembly through the circuit board;
one or more electrical contacts extending from the circuit board; and
a button housing configured to at least partially encase the circuit board, the one or more buttons, and the one or more electrical contacts;
wherein the button body assembly is capable of engagement and disengagement relative to a keypad housing while maintaining the functionality programmed into the circuit board.

2. The modular button assembly of claim 1, wherein the button cap includes an assembly of a top panel and a mounting plate.

3. The modular button assembly of claim 1, wherein the top panel and the mounting plate include complementary locating rings for alignment and coupling of the top panel to the mounting plate.

4. The modular button assembly of claim 1, wherein the button housing includes one or more openings configured to receive therethrough the one or more electrical contacts.

5. The modular button assembly of claim 1, wherein the one or more electrical contacts extends from an outer surface of the button body assembly for electrical coupling and decoupling relative to the keypad housing.

6. The modular button assembly of claim 1, wherein the button body assembly includes a mounting base and a light diffuser disposed at least partially within the mounting base.

7. The modular button assembly of claim 6, wherein the mounting base includes a body with a central opening and tapered inner walls, the tapered inner walls defining an angle complementary to tapered walls of the light diffuser.

8. The modular button assembly of claim 6, including one or more light emitting diodes (LEDs) electrically mounted to the circuit board and aligned with a bottom point of the light diffuser.

9. The modular button assembly of claim 1, wherein the button cap includes text indicating the functionality of the modular button assembly.

10. The modular button assembly of claim 1, wherein the button body assembly includes a base plate releasably engaged with the button housing and configured to at least partially enclose the one or more electrical contacts extending from the circuit board.

11. A reconfigurable keypad, comprising:
a housing including recessed portions with electrical contacts; and
at least one modular button assembly including:
a button cap; and
a button body assembly releasably coupled to the button cap, the button body assembly including:
a circuit board programmable with functionality of the modular button assembly;
one or more buttons coupled to the circuit board for controlling the functionality of the modular button assembly through the circuit board;
one or more electrical contacts extending from the circuit board; and
a button housing configured to at least partially encase the circuit board, the one or more buttons, and the one or more electrical contacts;
wherein the at least one modular button assembly is capable of engagement and disengagement relative to the recessed portions of the housing while maintaining the functionality programmed into the circuit board.

12. The reconfigurable keypad of claim 11, wherein the housing includes multiple rows of the recessed portions, and the at least one modular button assembly is capable of engagement and disengagement to any areas of the recessed portions of the housing.

13. The reconfigurable keypad of claim 11, wherein a position of the at least one modular button assembly relative to the recessed portions of the housing is interchangeable without affecting the functionality of the at least one of modular button assembly.

14. The reconfigurable keypad of claim 11, wherein the housing includes a faceplate extending from edges of a rear section of the housing and configured to be installed against an outer surface of a wall.

15. The reconfigurable keypad of claim 14, wherein the housing includes a removable front plate detachably coupled to the faceplate of the housing.

16. The reconfigurable keypad of claim 15, wherein the faceplate and the removable front plate include aligned openings capable of receiving the one or more modular button assemblies therethrough.

17. The reconfigurable keypad of claim 11, wherein the button cap comprises a multi-part design including an identifier plate coupled between a translucent outer plate and a mounting plate.

18. The reconfigurable keypad of claim 17, wherein the identifier plate is interchangeable.

19. The reconfigurable keypad of claim 11, wherein the button cap comprises a single-part design including an outer surface with identifier information formed in the outer surface, and a mounting or fastening structure extending from an opposing surface of the button cap.

20. A method of keypad reconfiguration, the method comprising:
inserting a modular button assembly into a first position of a recessed portion of a keypad housing to make an electrical contact of the housing with one or more electrical contacts of the modular button assembly, the modular button assembly including a button cap, and a button body assembly releasably coupled to the button cap, the button body assembly including (i) a circuit board programmable with a functionality of the modular button assembly, (ii) one or more buttons coupled to the circuit board for controlling the functionality of the modular button assembly through the circuit board, (iii) the one or more electrical contacts extending from the circuit board, and (iv) a button housing configured to at least partially encase the circuit board, the one or more buttons, and the one or more electrical contacts;
removing the modular button assembly from the first position of the recessed portion of the keypad; and
inserting the modular button assembly in a second position of the recessed portion of the keypad, the second position is different from the first position;
wherein the modular button assembly maintains the functionality programmed into the circuit board during insertion and removal of the modular button assembly from the recessed portion of the keypad.
